(19) United States
(12) Patent Application Publication
(10) Pub. No.: US 2008/0082995 A1
(43) Pub. Date: Apr. 3, 2008

(54) Method and apparatus for monitoring TV channel selecting status

(75) Inventors: Hiroshi Tanaka, Chiyoda-ku (JP); Osamu Tsuruta, Chiyoda-ku (JP); Yoshikazu Aoyama, Chiyoda-ku (JP)

Correspondence Address: JORDAN AND HAMBURG LLP, 122 EAST 42ND STREET, SUITE 4000, NEW YORK, NY, 10168, US

(73) Assignee: K.K. Video Research, Chiyoda-ku (JP)

(21) Appl. No.: 11/888,849

(22) Filed: Aug. 2, 2007

(30) Foreign Application Priority Data
Sep. 28, 2006 (JP) 2006-264548

(51) Int. Cl. H04H 9/00

(52) U.S. Cl. 725/18

(57) ABSTRACT

To accurately detect the channel being actually selected by a TV having built therein a digital tuner, a terminal device connected to the TV analyzes the preamble of a digital audio signal from the TV to thereby detect a change of audio data-type, and for each viewing period from the time of the change of audio data-type to the time of the next change of audio data-type, generates viewing block data containing comparison feature data extracted from data-bursts within the viewing period concerned and time data of the viewing period concerned, and transmits the generated viewing block data to a center apparatus. The center apparatus identifies, for each viewing block, the actually selected channel by making a comparison between the comparison feature data contained in the viewing block data received from the terminal device and reference feature data contained reference data of each channel stored in the reference data storage part.

### BACKGROUND OF THE INVENTION

(1) Field of the Invention

The present invention relates to a TV channel selecting status monitoring method and system for identifying the channel on which a particular TV program is being actually viewed.

(2) Description of the Prior Art

Heretofore, two kinds of systems, called a local matching system and a center matching system, respectively, have been used to detect or identify the channel on which a particular TV program is being actually viewed on the TV set (hereinafter referred to as a TV) of each viewer's home monitored for TV audience rating survey. The local matching system is one that performs, by monitoring equipment placed in the viewer's home, the whole processing including the channel identification as well as the collection of various data therefor. On the other hand, the center matching system is one that sends various data collected by the monitoring equipment placed in the viewer's home to a center apparatus.

A prior art example of the TV channel selecting status monitoring system using the local matching system is described in Japanese Patent No. 3669965 (hereinafter referred to as patent document 1). In the system set forth in patent document 1 (which system will hereinafter be referred to as a first prior art), the monitoring equipment set in the viewer's home decodes, for example, by an MPEG2-G decoder, a digital audio signal from a reference tuner of the same kind as the digital tuner incorporated in the TV into an analog audio signal, which is then compared in frequency spectrum with an audio signal from a loudspeaker of the TV to thereby identify the channel on which a particular program is being viewed, and the result of identification is sent to the center apparatus.

A prior art example of the TV channel selecting status monitoring system using the center matching system is described in Japanese Patent Publication No. 503636/97 (hereinafter referred to as patent document 2). In the system set forth in patent document 2 (which system will hereinafter be referred to as a second prior art), the monitoring equipment placed in the viewer's home detects, through utilization of a sudden change in sound or voice, tuning of the TV to a particular channel and hence a change of the TV channel, and extracts and stores a program signature (such as TV sound picked up by a microphone and TV scenes by a video camera) and time data immediately after the channel change. Thereafter, the stored data is sent to the center apparatus, which compares the received program signature with a reference signature prepared on the part of the center apparatus, thereby identifying the channel selected by the viewer.

Another prior art example of the TV channel selecting status monitoring system using the center matching system is disclosed in Japanese Patent Application Kokai Publication No. 286372/05 (hereinafter referred to as patent document 3). In the system set forth in patent document 3 (which system will hereinafter be referred to as a third prior art), upon interception or receipt of a TV remote-control signal, the monitoring equipment placed in the viewer's home extracts and stores the intercepted remote-control signal and the same program signature and time data as those needed in patent document 2. Thereafter, the stored data is sent to the center apparatus, which identifies the viewer's selected channel by comparing the received program signature with the reference signature prepared on the part of the center apparatus as well as by decoding the received remote-control signal.

Attention is now being given, in particular, to the center matching system because of its advantages over the local matching system including a quick response to the addition or cancellation of the channel being monitored and downsizing of the system configuration by disuse of the reference tuner in the monitoring equipment of the viewer's home. However, the TV channel selecting status monitoring system of the conventional center matching system have such problems as mentioned below.

First, where the time period from the start to the end of viewing on the same channel is defined as a “viewing block,” its exact detection by the monitoring equipment set in the viewer's home is difficult for the following reasons: that is, although in patent document 2 a sudden change in the TV speech or sound is decided or construed as indicative of a change of the TV channel, the TV speech or sound does not always suddenly change in response to the channel switching but instead it may sometimes undergo a sudden change even while the TV is being tuned to the same channel. In patent document 3 the interception of the TV remote-control signal is regarded as a possibility of the TV channel having been changed, but the remote-control signal is also sent to alter the volume of the TV other than for channel switching, and in addition, there is no guarantee that the monitoring equipment is capable of intercepting the remote-control signal which is received by the TV; on the contrary, the situation occasionally arises where the monitoring equipment would receive the remote-control signal that the TV failed to receive.

The difficulty of exact detection of the viewing block would give rise to such problems as mentioned below. A failure to detect a channel switching by the monitoring equipment causes a failure in channel detection, resulting in lowered accuracy of monitoring. Conversely, in the case of an erroneous detection of channel switching which does not actually take place, redundant data is sent from the monitoring equipment in the viewer's home to the center apparatus, increasing the load thereon.

Second, in the case of using, as the program signature, the sound or speech being broadcast on the channel to be monitored, if the sound or speech is almost silent, it is impossible to make channel identification. The reason for this is that although the first to third prior art systems compare the analog audio signals for channel identification, when the channel is in substantially a silent state, the analog audio signal of the channel does not ever appear or, if it appears, at a very low level substantially equal to a noise level.

### SUMMARY OF THE INVENTION

An object of the present invention is to enable accurate detection of the channel on which a TV program is being actually viewed on the TV having a built-in digital tuner.

Another object of the present invention is to enable accurate detection of the viewing block by the monitoring equipment placed in the viewer's home.

Still another object of the present invention is to enable accurate channel identification even if sound or voice being broadcast is almost silent.

According to a first aspect of the present invention, there is provided a TV channel selecting status monitoring method which identifies a channel being actually received by a TV which has at least one built-in digital tuner provides video and audio signals of the channel selected by said built-in digital tuner to a display and a loudspeaker, respectively, and has a digital audio output terminal through which to output a digital audio signal of said selected channel, said method comprising the steps:

a) wherein a terminal device connected to said TV detects a change of the audio data-type by analyzing a preamble of a data-burst generated from said digital audio signal output from said digital audio output terminal of said TV, and for each viewing period from the time of the change of audio data-type to the time of the next change of audio data-type, generates viewing block data containing comparison feature data extracted from said data-burst within said viewing period and containing time data on said viewing period;

b) wherein said terminal device sends said generated viewing block data to a center apparatus;

c) wherein said center apparatus receives said viewing block data from said terminal device and stores said received data in a comparison data storage part; and

d) wherein, for each viewing block data stored in said comparison data storage part, said center apparatus identifies said actually selected channel by making a comparison between said comparison feature data contained in said viewing block data and reference feature data extracted from each data-burst generated from a digital audio signal of said channel and contained in reference data together with time data on said data-burst.

According to a second aspect of the present invention, the TV channel selecting status monitoring method of the first aspect is characterized in that said step a) includes a step of extracting said comparison feature data from a predetermined part of said data-burst.

According to a third aspect of the present invention, the TV channel selecting status monitoring method of the second aspect is characterized in that said step a) includes a step of extracting said comparison feature data from only the data-burst within a certain time interval of said viewing period.

According to a fourth aspect of the present invention, the TV channel selecting status monitoring method of the third aspect is characterized in that said step a) includes a step of extracting said comparison reference data from all of a predetermined number of data-bursts from the start of said viewing period.

According to a fifth aspect of the present invention, the TV channel selecting status monitoring method of the fourth aspect is characterized in that said step a) includes a step of extracting said comparison reference data from only some of data-bursts subsequent to said predetermined number of data-bursts.

According to a sixth aspect of the present invention, the TV channel selecting status monitoring method of the fifth aspect is characterized in that said step d) includes a step of retrieving reference data of a channel having reference feature data coincident with said predetermined number of comparison reference data contained in said viewing block data, and in the case of said retrieval being successful, making a check to see if comparison feature data except said predetermined number of comparison reference data coincides with reference data of the channel concerned.

According to a seventh aspect of the present invention, the TV channel selecting status monitoring method of the first aspect is characterized in that said step d) includes a step of performing a real-time channel decision processing of making a comparison between reference feature data of substantially the same time data as that contained in said viewing block data and said comparison feature data in said viewing block data.

According to an eighth aspect of the present invention, the TV channel selecting status monitoring method of the first aspect is characterized in that said step d) includes a step of performing a time-shift channel decision processing of making a comparison between reference feature data of time data earlier than the time data contained in said viewing block data and said comparison feature data in said viewing block data.

According to a ninth aspect of the present invention, there is provided a TV channel selecting status monitoring system which identifies a channel being actually received by a TV which has at least one built-in digital tuner, provides video and audio signals of the channel selected by said built-in digital tuner to a display and a loudspeaker, respectively, and has a digital audio output terminal through which to output a digital audio signal of said selected channel, said system comprising:

a terminal device connected to said TV; and

a center apparatus capable of communicating with said terminal device;

wherein said terminal device comprises:

a viewing block data generating part which detects a change of the audio data-type identifying part by analyzing a preamble of a data-burst generated from said digital audio signal output from said digital audio output terminal of said TV, and for each viewing period from the time of the change of the audio data-type identifying part to the time of the next change of the audio data-type identifying part, generates viewing block data containing comparison feature data extracted from said data-burst within said viewing period and containing time data on said viewing period;

a storage part for storing said generated viewing block data; and

a communication part for transmitting said viewing block data stored in said storage part to said center apparatus; and

wherein said center apparatus comprises;

a comparison data storage part for storing said viewing block data transmitted from said terminal device;

a reference data storage part for storing, for each channel monitored for identification, reference data containing reference feature data extracted from a data-burst generated from the digital audio signal of said channel concerned and time data of said data-burst; and

a channel decision processing part for making a decision, for each viewing block data stored in said comparison data storage part, on the channel being monitored for identification by making a comparison between feature data contained in said viewing block data and reference feature data contained in reference data on each channel stored in said reference data storage part.

According to a tenth aspect of the present invention, the TV channel selecting status monitoring system of the ninth aspect is characterized in that said viewing block data generating part extracts said comparison feature data from a predetermined part of said data-burst.

According to an 11th aspect of the present invention, the TV channel selecting status monitoring system of the 10th aspect is characterized in that said viewing block data generating part extracts said comparison feature data from only the data-burst within a certain time interval of said viewing period.

According to a 12th aspect of the present invention, the TV channel selecting status monitoring system of the 11th aspect is characterized in that said viewing block data generating part extracts said comparison feature data from all of a predetermined number of data-bursts from the start of said viewing period.

According to a 13th aspect of the present invention, the TV channel selecting status monitoring system of the 12th aspect is characterized in that said viewing block data generating part extracts said comparison reference data from only some of data-bursts subsequent to said predetermined number of data-bursts.

According to a 14th aspect of the present invention, the TV channel selecting status monitoring system of the 13th aspect is characterized in that said channel decision processing part retrieves reference data of a channel having reference feature data coincident with said predetermined number of comparison reference data contained in said viewing block data, and in the case of said retrieval being successful, makes a check to see if comparison feature data except said predetermined number of comparison reference data coincides with reference data of said channel concerned.

According to a 15th aspect of the present invention, the TV channel selecting status monitoring system of the ninth aspect is characterized in that said channel decision processing part performs a real-time channel decision processing of making a comparison between reference feature data of substantially the same time data as that contained in said viewing block data and said comparison feature data in said viewing block data.

According to a 16th aspect of the present invention, the TV channel selecting status monitoring system of the ninth aspect is characterized in that said channel decision processing part performs a time-shift channel decision processing of making a comparison between reference feature data of time data earlier than the time data contained in said viewing block data and said comparison feature data in said viewing block data.

According to a 17th aspect of the present invention, there is provided a terminal device comprising:

a viewing block data generating part which detects a change of the audio data-type by analyzing a preamble of a data-burst generated from a digital audio signal output from a digital audio output terminal of a TV, and for each viewing period from the time of the change of audio data-type to the time of the next change of audio data-type, generates viewing block data containing comparison feature data extracted from a data-burst within said viewing period and containing time data on said viewing period;

a storage part for storing said generated viewing block data; and

a communication part for transmitting said viewing block data stored in said storage part to a center apparatus.

According to an 18th aspect of the present invention, the terminal device of the 17th aspect is characterized in that that said viewing block data generating part extracts said comparison feature data from a predetermined part of said data-burst.

According to a 19th aspect of the present invention, the terminal device of the 18th aspect is characterized in that that said viewing block data generating part extracts said comparison feature data from only the data-burst within a certain time interval of said viewing period.

According to a 20th aspect of the present invention, the terminal device of the 19th aspect is characterized in that that said viewing block data generating part extracts said comparison feature data from all of a predetermined number of data-bursts from the start of said viewing period.

According to a 21st aspect of the present invention, the terminal device of the 20th aspect is characterized in that that said viewing block data generating part extracts said comparison feature data from only some of data-bursts subsequent to said predetermined number of data-bursts.

According to a 22nd aspect of the present invention, there is provided a center apparatus comprising:

a comparison data storage part for receiving from a terminal device and storing viewing block data containing comparison feature data extracted from a data-burst generated from a digital audio signal of a TV within a viewing period from the start to the end of tuning of said TV to the same channel and containing time data of said viewing period;

a reference data storage part for storing, for each channel monitored for identification, reference data containing reference feature data extracted from a data-burst generated from the digital audio signal of said channel concerned and time data of said data-burst; and

a channel decision processing part for making a decision, for each viewing block data stored in said comparison data storage part, on the channel being monitored for identification by making a comparison between feature data contained in said viewing block data and reference feature data contained in reference data on each channel stored in said reference data storage part.

According to a 23rd aspect of the present invention, the center apparatus of the 22nd aspect is characterized in that said channel decision processing part performs a real-time channel decision processing of making a comparison between reference feature data of substantially the same time data as that contained in said viewing block data and said comparison feature data in said viewing block data.

According to a 24th aspect of the present invention, the center apparatus of the 22nd aspect is characterized in that said channel decision processing part performs a time-shift channel decision processing of making a comparison between reference feature data of time data earlier than the time data contained in said viewing block data and said comparison feature data in said viewing block data.

According to a 25th aspect of the present invention, the center apparatus of the 22nd aspect further comprising:

reference data generating parts each provided in correspondence to one of channels to be identified, for generating reference data which contains reference feature data extracted from each data-burst generated by decoding a digital audio signal from a digital tuner for selecting said corresponding channel and time data of said data burst concerned, and for sending said reference data to said reference data storage part.

### Operation

Many of TVs with a digital tuner built therein are provided with a digital audio output terminal for outputting therethrough a digital audio signal of the channel selected by the digital tuner. The digital audio signal, which is provided from the digital audio output terminal, is a signal encoded by a biphase-mark scheme as defined in IEC (INTERNATIONAL ELECTROTECHNICAL COMMISSION) 60958-1. This signal is decoded to obtain a linear PCM audio signal defined in the IEC60958 series, or a nonlinear PCM audio signal defined in the IEC61937 series. With the nonlinear PCM audio signal, it is possible to generate a data-burst defined in IEC61937-1. The data-burst is composed of four kinds of preamble signals and a burst-payload. In the case of digital broadcasting in our country, MPEG-AAC data, which is a kind of the nonlinear PCM type, is stored in the burst-payload. And, the audio data-types are recorded in a preamble signal Pc that is one of the four kinds of preamble signals. More specifically, audio data-types belonging to linear PCM, such as MPEG2-AAC, PAUSE, Null date, are indicated by the preamble signal Pc.

In the case of watching a program on a certain channel of a digital broadcast selected by the TV digital tuner, the audio data-type retains a predetermined type as long as the channel is held unchanged. The predetermined type differs from country to country; for example, in Japan it is MPEG2-AAC. This will be described below in connection with the case of Japan, but the explanation applies as well to the cases of countries using different audio data-types. When the channel is changed, the audio data-type temporarily goes PAUSE or Null data, and when the channel switching is completed to select a different channel, the audio data-type returns to MPEG2-AAC.

Accordingly, the terminal device connected to the TV set in the viewer's home detects a change of audio data-type by analyzing the preamble of a data-burst generated from the digital audio signal provided from the digital audio output terminal of the TV, and obtains the viewing period from the time of audio data-type switching to PAUSE, Null data, or the like to the time of the next audio data-type switching; this viewing period exactly coincides with one viewing block.

The terminal device according to the present invention generates viewing block data containing comparison feature data sampled, under predetermined rules, from the data-bursts within the viewing period obtained as mentioned above, and time data containing at least one of the starting and finishing times of the viewing period, and transmits the viewing block data to the center apparatus.

The center apparatus stores the viewing block data from the terminal device in the comparison data storage part. The center apparatus includes, separately of the comparison data storage part, the reference data storage part which stores, for each channel monitored for identification, reference data containing reference feature data extracted from the data-burst generated from the digital audio signal of the channel concerned and time data of the data-burst. The center apparatus makes a decision, for each viewing block data stored in the comparison data storage part, on the channel being monitored for identification by making a comparison between feature data contained in the viewing block data concerned and reference feature data contained in reference data on each channel stored in the reference data storage part. In the case of performing the real-time channel decision processing, since a time lag occurs between the digital audio signal from the digital tuner of the TV and the digital audio signal from the digital tuner of the center apparatus due to delays in the circuit operation of tuner sets and in their processing, the timing for decoding broadcast waves, or the like, a mere comparison of the contents of data-bursts generated at the same time is incomplete for identification of the channel being selected, and therefore, the center apparatus makes the comparison in consideration of a time-base delay.

### BRIEF DESCRIPTION OF THE DRAWINGS

FIG. 1 is a block diagram of the TV channel selecting status monitoring system according to an embodiment of the present invention;

FIG. 2 is a flowchart showing in outline the operation of the TV channel selecting status monitoring system of FIG. 1;

FIG. 3 is a block diagram of a terminal device for use in the FIG. 1 embodiment;

FIG. 4 is a diagram showing, by way of example, the format of a data-burst and the extraction of comparison data;

FIG. 5 is a diagram showing an example of the structure of viewing block data;

FIG. 6 is a diagram for explaining how to generate the viewing block data:

FIG. 7 is a block diagram of a reference data generating part of a center apparatus for use in the FIG. 1 embodiment;

FIG. 8 is a diagram showing an example of the structure of reference data;

FIG. 9 is a diagram for explaining how to generate the reference data;

FIG. 10 is a block diagram of a reference data storage part of the center apparatus in the FIG. 1 embodiment;

FIG. 11 is a block diagram of a comparison data storage part of the center apparatus in the FIG. 1 embodiment;

FIG. 12 is a block diagram of a channel identification processing part of the center apparatus in the FIG. 1 embodiment;

FIG. 13 is a flowchart showing a channel decision part of the channel identification processing part of the center apparatus in the FIG. 1 embodiment;

FIG. 14 is a flowchart showing an example of real-time channel identification processing which is performed by the channel decision part of the channel identification processing part in the FIG. 1 embodiment; and

FIG. 15 is a diagram for explaining the real-time channel identification processing.

### DETAILED DESCRIPTION OF THE PREFERRED EMBODIMENTS

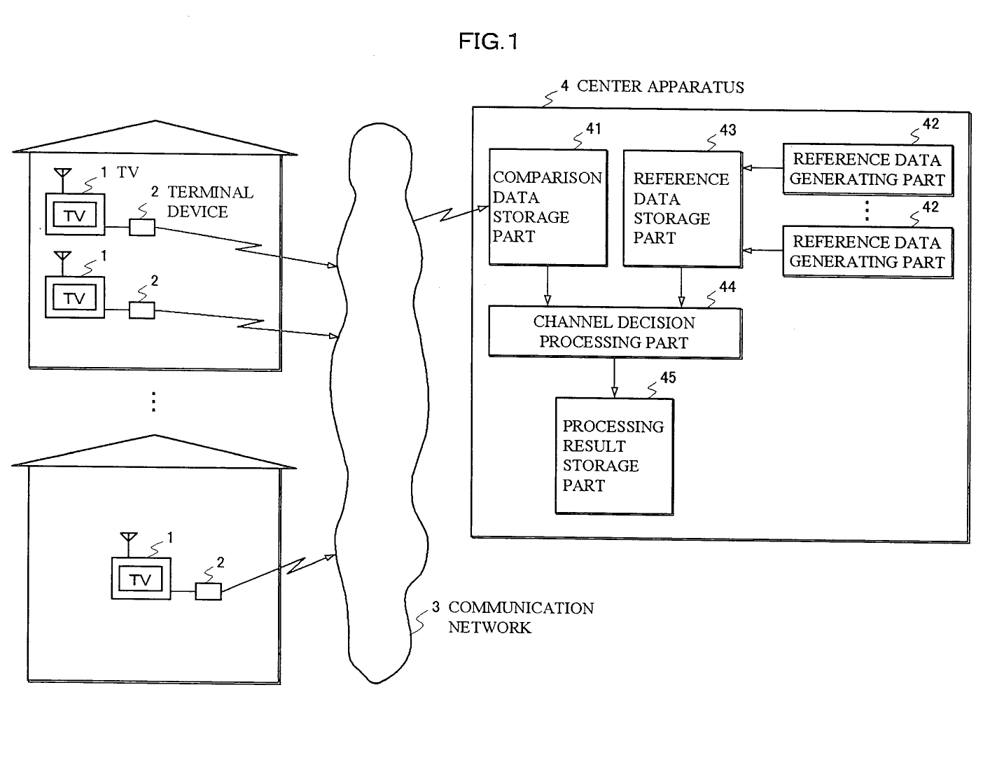

Referring first to FIG. 1, the TV channel selecting status monitoring system according to an embodiment of the present invention is made up of a terminal device 2 connected to a TV set in a sample viewer's home and a center apparatus 4 capable of communicating with the terminal device 2 over a communication network 3. The communication network 3 is a public telephone circuit network, public radio circuit network, the Internet, or similar communication network.

The TV 1 has at least one built-in digital tuner, provides video and audio signals of the channel selected by the built-in digital tuner to a display and a loudspeaker, respectively, and has a digital audio output terminal through which to output the digital audio signal of the selected channel.

The terminal device 2 is provided for each TV 1 and has the functions of: detecting switching of the audio data-type identifying part by analyzing the preamble of a data-burst generated from the digital audio signal which is output via the digital audio output terminal; for each viewing period from the time of switching of the audio data-type to the time of next switching, generating viewing block data containing feature data for comparison (hereinafter referred to as comparison feature data) extracted from the data-bursts within the current viewing period and time data on the viewing period, and sending the thus generated viewing block data via the communication network 3 to the center apparatus 4.

The center apparatus 4 is comprised of: a comparison data storage part 41 for receiving and storing the viewing block data sent from the terminal device 2; a reference data generating part 42 for generating a reference data containing reference feature data extracted from a data-burst generated by decoding the digital audio signal output from the digital tuner selecting the current channel and time data on the data-burst; a reference data storage part 43 for storing the reference data generated in the reference data generating part 42; a channel decision (or identification) processing part 44 which, for each viewing block data from each terminal device 2 stored in the comparison data storage part 41, makes a comparison between the comparison feature data contained in the viewing block data and reference feature data contained in the reference data stored in the reference data storage part 43 for each channel to thereby decide or identify the channel being actually viewed; and a processing result storage part 45 for storing the decision result by the channel decision processing part 44.

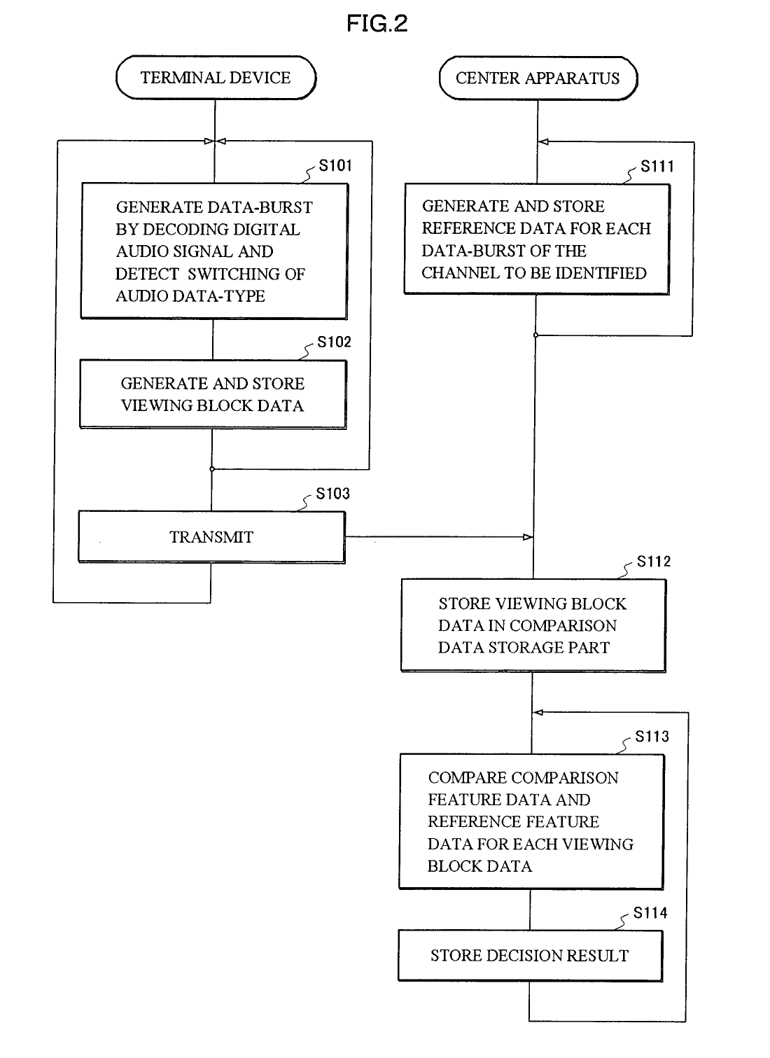

A description will be given, with reference to FIGS. 1 and 2, of the entire operation of the TV channel selecting status monitoring system according to this embodiment.

Each terminal device 2 generates a data-burst by decoding the digital audio signal provided from the digital audio output terminal of the TV 1 to which the terminal device 2 is connected, and analyzes the preamble of the data-burst to thereby detect switching of the audio data-type (step S101 in FIG. 2). Then, for each viewing period from the time of switching of the audio data-type to the time of the next switching, the terminal device 2 generates and stores viewing block data containing comparison feature data extracted from the data-burst within the current viewing period and time data on the current viewing period (step S102). The terminal device 2 always executes the processing of steps S101 and S102 during the ON state of the TV power supply. And, upon transmission timing being reached such as the conclusion of a predetermined elapsed time, all pieces of viewing block data stored until then are sent from the terminal device 2 via the communication network 3 to the center apparatus 3 (step S103). In this instance, attribute data for specifying the TV 1 of a particular viewer's home to which each piece of viewing block data belongs may be appended to the viewing block data, or on a transmission-datawise basis.

On the other hand, in the center apparatus 4 each reference data generating part 42 generates the burst by decoding the digital audio signal provided from the digital tuner tuned to the channel for identification, then for each piece of data-burst, generates the reference data containing the reference feature data extracted from the data-burst and the time data on the data-burst, and stores the reference data in the reference data storage part 43 (step S111 in FIG. 2). The processing of step S111 always continues during broadcasting of a program or programs on the channel to be identified.

Upon receiving the viewing block data from the terminal device 2 over the communication network 3, the comparison data storage part 41 of the center apparatus 4 stores the received data (step S112). Thereafter, the channel decision processing part 44 compares, for each piece of viewing block data stored in the comparison data storage part 41, the comparison feature data contained in the viewing block data and the reference feature data contained in the reference data stored for each channel in the reference data storage part 43, thereby deciding or identifying the channel selected during the viewing block (step S113). The processing of steps S113 and S114 repeats for every piece of viewing block data stored in the comparison data storage part 41.

Next, a detailed description will be given of the terminal device 2 and the center apparatus 4.

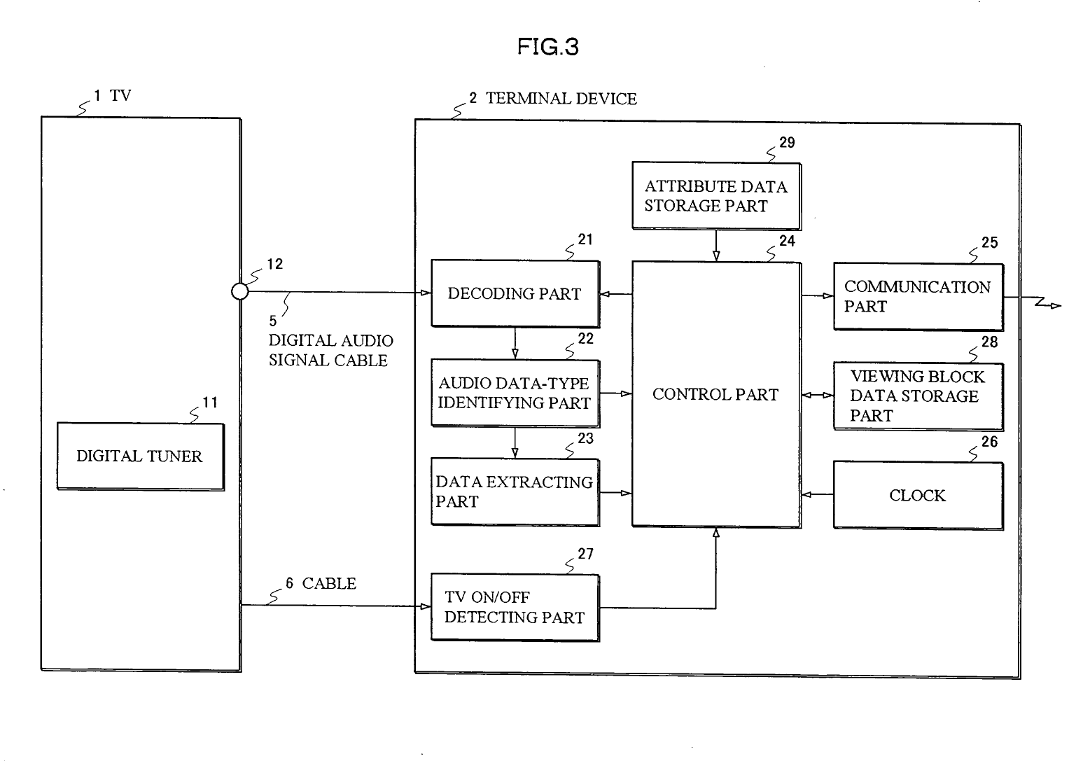

FIG. 3 illustrates in block form an example of the terminal device 2, which is composed of a decoding part 21, an audio data-type identifying part identification part 22, a data extracting part 23, a control part 24, a communication part 25, a clock 26, a TV ON/OFF detecting part 27, a viewing block data storage part 28, and an attribute data storage part 29.

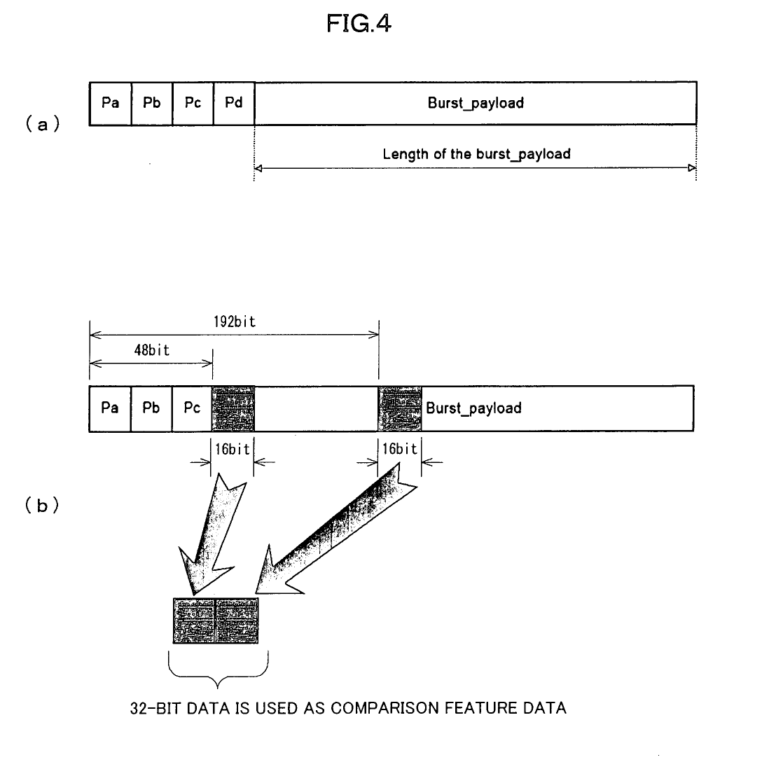

The decoding part 21 receives the digital audio signal from the digital audio signal output terminal 12 of the TV 1 over a digital audio signal cable 5, such as an optical digital cable or coaxial cable, and generates an IEC60958-1-defined sub-frame from the received digital audio signal. In the case of nonlinear PCM type, the decoding part 21 further generates from the sub-frame an IEC61937-1-defined data-burst, and provides the data-burst to the audio data-type identifying part 22. The data-burst defined by IEC61937-1 is made up of, as shown in FIG. 4(a), four 16-bit preamble signals a to d (Pa to Pd) and an immediately subsequent burst-payload; in the case of digital broadcasting in Japan, MPEG2-AAC data, which is a kind of the nonlinear format, is recorded in the burst-payload. Further, constants “F872” and “4E1F” are set in the preamble signals Pa and Pb, respectively, audio data-type information is set in the preamble signal Pc, and the frame length is set in the preamble signal Pd.

The audio data-type identifying part 22 detects a change of the audio data-type by analyzing the preamble signal Pc of the data-burst, then at the time of change of audio data-type, posts the start of the viewing block to the data extracting part 23 and the control part 24, and at the time of the next change of audio data-type, posts the conclusion of the viewing block to the control part 24. Furthermore, the audio data-type identifying part 22 provides to the data extracting part 23 the data-bursts generated in the decoding part 21 during the period from the start of the viewing block to the end thereof.

The data extracting part 23 follows predetermined rules to extract the comparison reference data from the data-burst and provides it to the control part 24.

The position at which to extract the comparison reference data from the data-burst may be anywhere in the burst-payload. The comparison reference data may also be extracted from the preamble signal Pd that indicates the frame length. For example, in FIG. 4(b) 16 bits after a 48th bit from the beginning of the data-burst (i.e., the preamble signal Pd) and 16 bits after a 192nd bit, that is, a total of 32 bits is extracted as the comparison reference data. Incidentally, the number of bits to be extracted from one data-burst, that is, the size of the comparison reference data, is not limited specifically to 32 bits but it may also be 8 bits, 16 bits, or like arbitrary number of bits. Also the comparison reference data may be a bit string subjected to a predetermined arithmetic operation, such as an 8-bit XOR of two 8-bit strings extracted from the data-burst at different positions.

The data-burst from which to extract the comparison reference data may be all the data-bursts provided from the audio data-type identifying part 22, that is, all data-bursts within the viewing block, but they can also be thinned out as desired to reduce the amount of data to be processed. In this embodiment, the comparison reference data is extracted from all data-bursts up to a predetermined K-th one from the beginning of the viewing block, thereafter being extracted from those thinned out down to 1/L, where K and L are positive integers equal to or greater than 2. For example, letting K=200 and L=50, the comparison reference data is extracted from all of 1st to 200th data-bursts, and 201st and subsequent data-bursts are thinned out down to 1/50. In other words, the comparison reference data is extracted once every 50 data-bursts, such as 250th, 300th, and so on. The data-burst defined by IEC61937-1 is generated approximately every 20 ms; therefore, according to the above method, the comparison reference data is extracted from all data-bursts for 4 seconds after the beginning of the viewing block, and thereafter the comparison reference data is extracted from the data-burst appearing every second.

The TV ON/OFF detecting part 25 is connected via a cable 6 to the TV 1, and detects and posts the ON/OFF state of the TV 1 to the control part 24. The detection method may be an arbitrary one that utilizes, for example, the power consumption of the TV 1 or leak noise from an inverter fan or high voltage circuit of the TV 1.

The clock 26 provides the current time to the control part 24. The current time information is provided in the form of year-month-day-hour-minute-second.

The attribute data storage part 29 is formed by a ROM or the like, and prestores attribute data for specifying the TV 1. The attribute data includes, for instance, an area number, a sample number, and a TV number. The area number is a number that uniquely identifies the area where the viewer's home exists; the sample number is a number that uniquely identifies the viewer's home in the area concerned; and the TV number is a number that uniquely identifies the TV in the viewer's home concerned.

The viewing block data storage part 28 is formed by a RAM, hard disk, or the like, and stores viewing block data. The viewing block data is composed of: the attribute data including the area number, the sample number and the TV number; viewing block starting time data; comparison feature data (1), (2), . . . , (n) extracted from data-bursts; and viewing block finishing time data.

The communication part 25 has the function of transmitting, over the communication network 3, the viewing block data stored in the viewing block data storage part 28 to the comparison data storage part 41 of the center apparatus 4. Incidentally, in the case where an intermediary device called an online meter for transmitting the viewing block data is interposed between the terminal device 2 and the center apparatus 4, the viewing block data may also be sent to the intermediary device by wire or by radio.

The control part 24 governs the generation of the viewing block data and the overall operation of the terminal device 2. Upon detection of power-ON of the TV 1 by the TV ON/OFF detecting part 27, the control part 24 starts the decoding part 21, causing it to start decoding of the digital audio signal that is input thereto from the output terminal 12 of the TV 1 via the cable 5. Thereafter, upon receiving from the audio data-type identifying part 22 information indicating the start of the viewing block, the control part 24 reserves in the viewing block data storage part 28 a free space for a new piece of viewing block data, and writes the attribute data read out of the attribute data storage part 29 and the current time (used as viewing block starting time data) read out of the clock 26 at the head of the free space. Then, until receiving from the audio data-type identifying part 22 information indicating the conclusion of the viewing block, the control part 24 writes the comparison reference data extracted by the data extracting part 23 in the viewing block data storage part 28 in order of extraction. Upon receiving information indicating the conclusion of the viewing block, the control part 24 writes the current time (as the viewing block finishing time data), completing one piece of viewing block data.

Upon detection of power-OFF of the TV 1 by the TV ON/OFF detecting part 27, the control part 24 stops the decoding part 21 from operation. Further, when predetermined transmission timing is reached, the control part 24 starts the communication part 25, which in turn transmits the viewing block data stored in the viewing block data storage part 28 to the center apparatus 4.

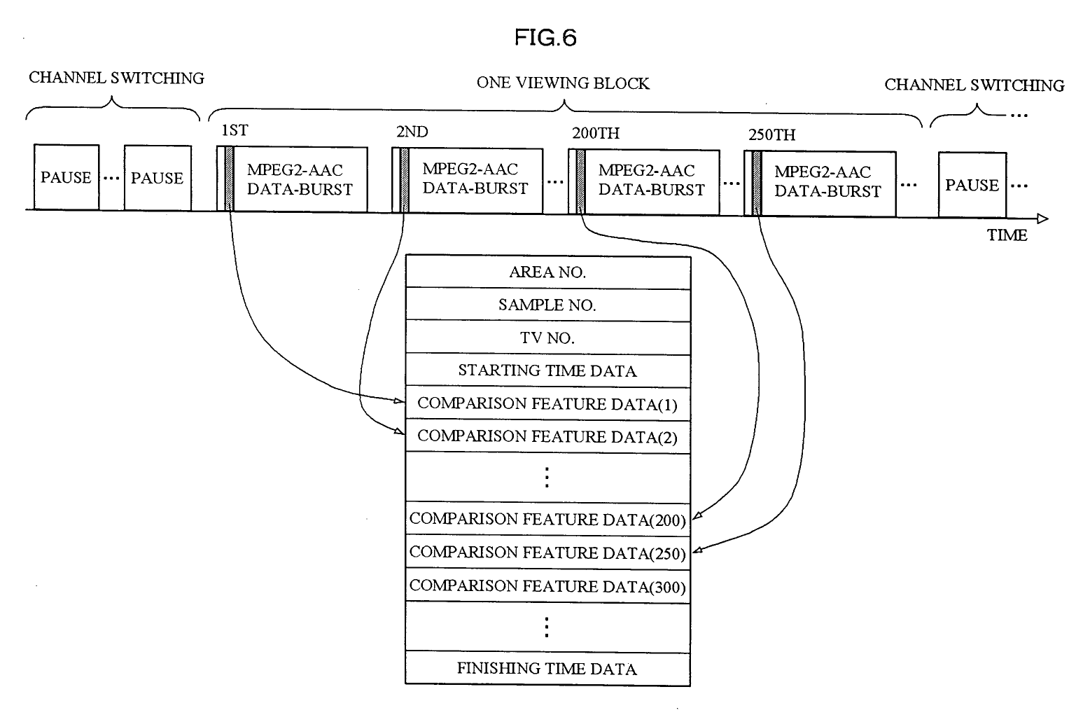

FIG. 6 illustrates an example of the viewing block data generated in the terminal device 2. When the channel of the TV 1 is changed, the audio data-type identifying part of the data-burst during the switching period temporarily goes PAUSE, and when the channel change is completed, it returns to the nonlinear PCM (MPEG2-AAC) audio data-type identifying part. The audio data-type identifying part identifying part 22 detects the switching of audio data-type identifying part, and posts the start of the viewing block to the data extracting part 23 and the control part 24. The control part 24 writes at the head of the viewing block data the attribute data composed of the area number, the sample number and the TV number and the starting time data obtained from the clock 26. The data extracting part 23 extracts the comparison feature data from each of the 1st to 200th data-bursts of the viewing block, and provides the extracted comparison feature data to the control part 24; as for 201st and subsequent data-bursts, after which the extracting part 23 extracts the comparison feature data every 50 data-bursts, and provides the extracted data to the control part 24. The control part 24 writes the individual pieces of comparison feature data from the data extracting part 23 in the viewing block data in order of extraction. When the channel of the TV 1 is changed again, the audio data-type identifying part of the data-burst changes to PAUSE, which the audio data-type identifying part identifying part 22 interprets as the conclusion of the viewing block, and posts it to the control part 24. The control part 24 writes the finishing time data read out of the clock 26 at the end of the viewing block, completing one piece of viewing block. The individual pieces of viewing block data thus created and stored in the viewing block data storage part 28 are sorted in the order of the viewing starting time and sent to the center apparatus 4.

Now, the center apparatus 4 will be described in detail.

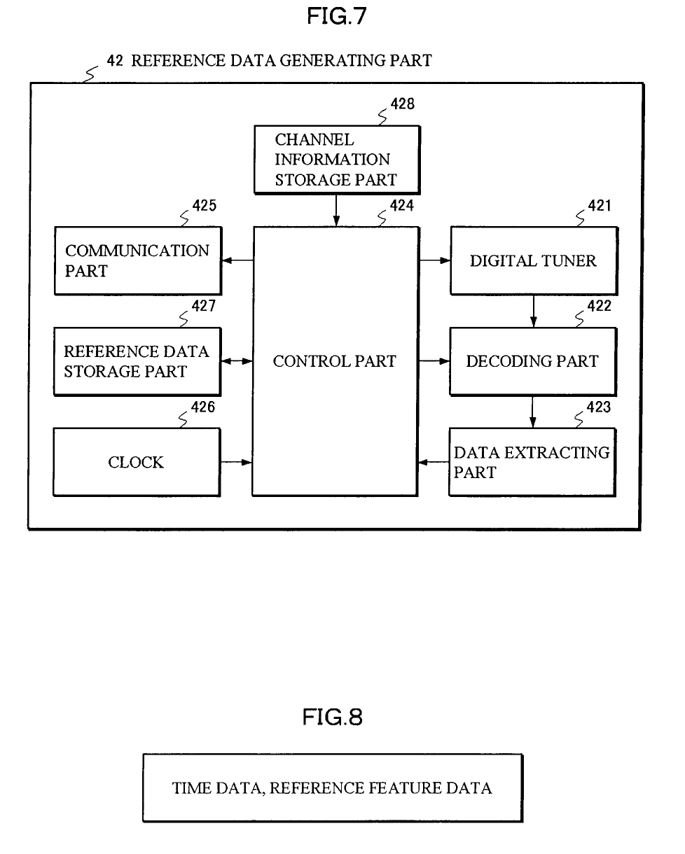

Referring to FIG. 7, the reference data generating part 42 of the center apparatus 4 is made up of a digital tuner 421, a decoding part 422, a data extracting part 423, a control part 424, a communication part 425, a clock 426, a reference data storage part 427, and a channel information storage part 428.

The digital tuner 421 is one that receives a digital broadcast of the channel to be identified, selects the channel specified by the control part 424 and outputs the digital audio signal of the selected channel to the decoding part 422.

The decoding part 422 generates the IEC60958-1-defined sub-frame from the digital audio signal provided from the digital tuner 421, and generates the IEC61937-1-defined data-burst from the sub-frame, thereafter providing the data-burst to the data extracting part 423.

The data extracting part 423 follows predetermined rules to extract the reference feature data from the data-burst and provides it to the control part 424. The position of extraction of the reference feature data from the data-burst, the number of bits to be extracted and the kind of arithmetic operation of the extracted bits are the same as in the case of extracting the comparison reference data from the data-burst by the data extracting part 23 of the terminal device 2. The data extracting part 23 of the terminal device 2 thins out the data-bursts from which to extract the comparison feature data, whereas the data extracting part 423 of the reference data generating part 42 extract the reference feature data from every data-burst.

The clock 426 provides the current time to the control part 424. As is the case with the clock 26 of the terminal device 2, the current time is provided in the form of year-month-day-hour-minute-second, for instance.

The channel information storage part 428 prestores information on the channel to which the reference data generating part 42 concerned is assigned.

The reference data storage part 427 is formed by a RAM, hard disk, or the like, and stores the reference data. One piece of reference data is formed by a pair of time data and reference feature data as depicted in FIG. 8.

The communication part 425 has the function of transmitting the sequence of reference data stored in the reference data storage part 427 to the reference data storage part 43. The transmission is carried out by wire or by radio. In this instance, the channel information stored in the channel information storage part 428 is added to the reference data to clarify the channel corresponding thereto.

The control part 424 governs the creation of the reference data and the overall operation of the reference data generating part 42. The control part 424 causes the digital tuner 421 to select the channel specified by the channel information stored in the channel information storage part 428. Thereafter, the decoding part 422 generates a data-burst from the digital audio signal that is provided from the digital tuner 421, and each time the decoding part 422 extracts the reference feature data from the data-burst, the control part 424 generates reference data containing the extracted reference feature data and the current time read out of the clock 426, and stores the reference data in the reference data storage part 427. On predetermined transmission timing being reached, the control part 424 starts the communication part 425, and transmits therethrough the pieces of reference data stored in the reference data storage part 427 to the reference data storage part 43, together with the channel information.

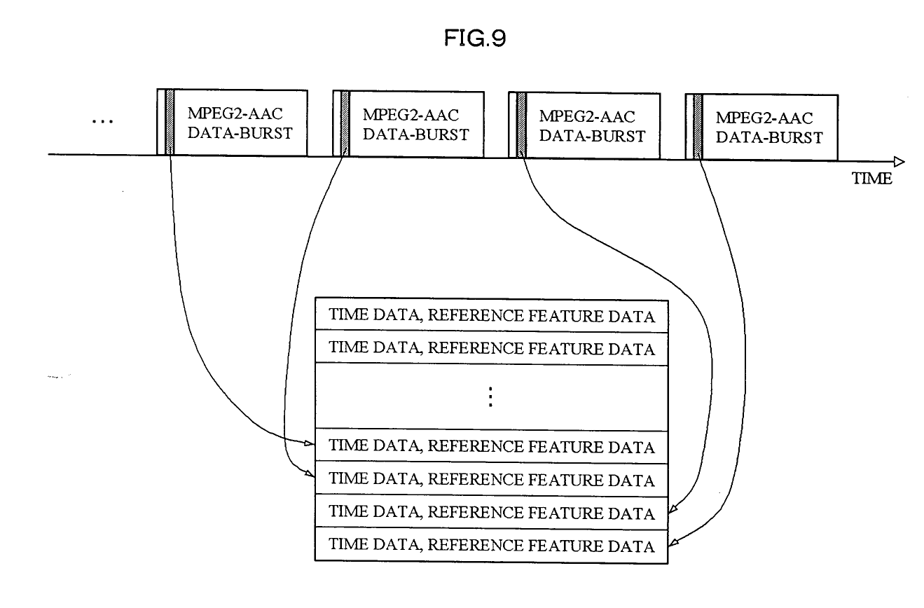

FIG. 9 shows an example of the reference data generated in the reference data generating part 42. Each time the data-burst is generated by the decoding part 422 from the digital audio signal that is output from the digital tuner 421 tuned to the channel to be identified, the data extracting part 423 extracts the reference feature data from the data-burst, and the control part 424 stores the extracted reference feature data in the reference data storage part 427, together with the time data at that point. The pieces of reference data thus stored in the reference data storage part 427 are sorted in order of time data and transmitted to the reference data storage part 43.

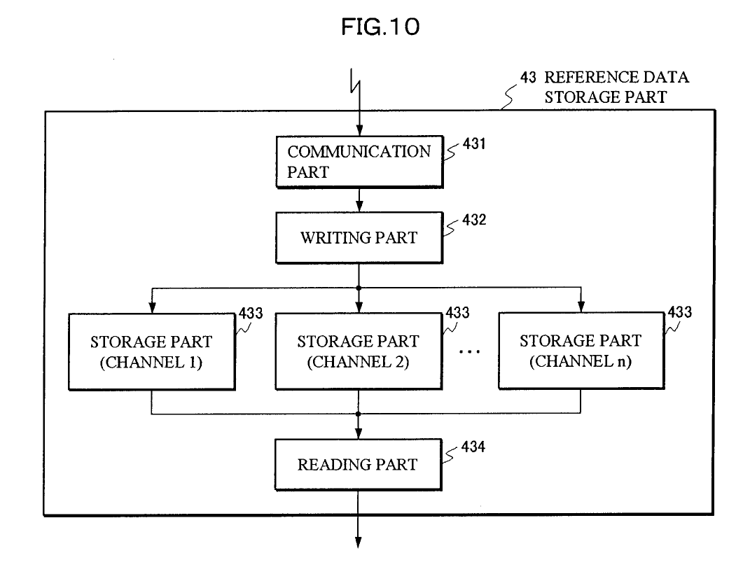

Referring to FIG. 10, the reference data storage part 43 of the center apparatus 4 is composed of a communication part 431, a writing part 432, a storage parts 433 each corresponding to one particular channel, and a reading part 434.

The communication part 431 provides the reference data and channel information received from the reference data generating part 42 to the writing part 432.

The writing part 432 has the function of writing the reference data from the communication part 431 in that one of the storage parts 433 which corresponds to the channel information received from the communication part 431.

The storage parts 433 are each formed by a hard disk or the like, and store a file of a capacity large enough to store the reference data on the corresponding channel for a fixed period. To indicate the file of which storage part 433 stores the reference data of which channel to be identified, it is possible, for example, to append the channel information to the file name.

The reading part 434 responds to an instruction from the channel identification processing part 44 to read out the reference data on the specified channel from the corresponding storage part 433.

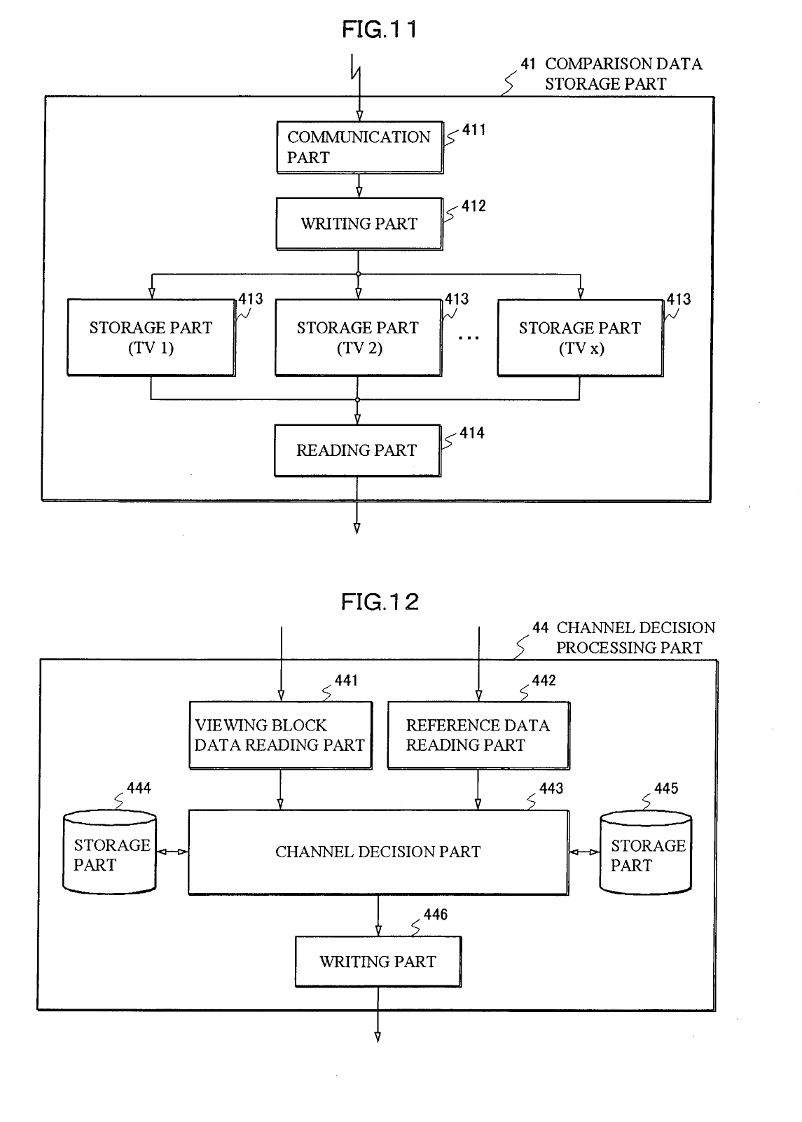

Referring next to FIG. 11, the comparison data storage part 41 of the center apparatus 4 is made up of a communication part 411, a writing part 412, storage parts 413 each corresponding to one particular TV, and a writing part 414.

The writing part 412 has the function of writing the viewing block data from the communication part 411 in that one of the storage parts 413 which corresponds to the TV 1 that is uniquely specified by the attribute data (the area, sample number and TV numbers) on the viewing block data concerned.

The storage parts 413 are each formed by a hard disk or the like, and stores a file of a capacity large enough to store a fixed amount of viewing block data. For example, by appending the area, sample and TV numbers to the file name, it is possible to indicate the stored viewing block data corresponding to the TV of the appended area, sample and TV numbers.

The reading part 414 responds to an instruction from the channel identification processing part 44 to read out the specified viewing block data from the storage part 413 corresponding thereto.

Turning next to FIG. 12, the channel identification processing part 44 of the center apparatus 4 comprises a viewing block data reading part 441, a reference data reading part 442, an channel decision part 443, storage parts 444, 445, and a writing part 446.

The viewing block data reading part 441 reads out of the comparison data storage part 41 the viewing block data to be processed for channel identification.

The reference data reading part 442 reads out the reference data from the reference data storage part 441.

The storage part 444 is used to temporarily store the viewing block data read out by the viewing block data reading part 441, and the storage part 445 is used to temporarily store the reference data read out by the reference data reading part 442.

The writing part 446 writes the result of processing by the decision part 444 in the processing result storage part 45.

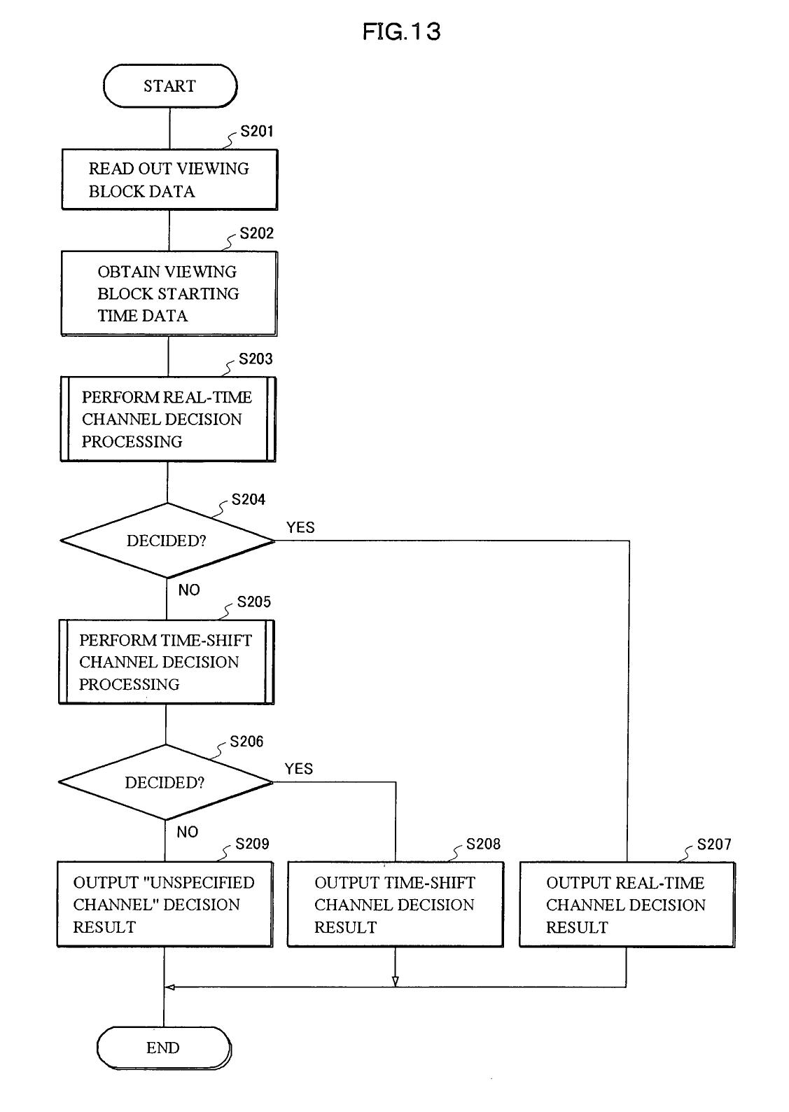

The channel decision part 443 identifies the selected channel by collating each piece of viewing block data stored in the comparison data storage part 41 with the reference data stored in the reference data storage part 43. FIG. 13 shows an example of processing by the decision part 443 for each piece of viewing block data.

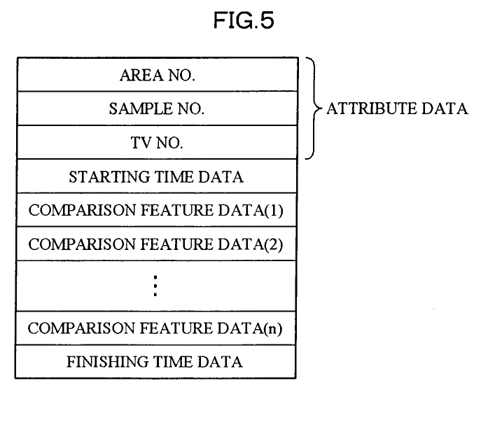

Referring next to FIG. 13, the decision part 443 reads out one piece of viewing block data to be processed from the comparison data storage part 41 through the viewing block data reading part 441, and stores the read-out data in the storage part 444 (step S201). As described previously, the viewing block data has such a data structure as depicted in FIG. 5.

Next, the decision part 443 obtains the starting time data recorded in the viewing block data (step S202), and performs a real-time channel identification processing of collating the viewing block data with the reference data of substantially the same time as that of the obtained starting time data (step S203). And, if the real-time channel identification processing succeeds in specifying the selected channel (YES in step S204), then the decision part 443 writes the result of real-time channel identification processing in the processing result storage part 45 through the writing part 446 in correlation to the attribute data of the viewing block data concerned (step S207).

On the other hand, if the real-time channel identification processing fails to specify the selected channel (NO in step S204), then the decision part 443 performs a time-shift channel identification processing of collating the viewing block data with reference data earlier than the staring time obtained from the viewing block data so as to investigate the possibility of a videotaped TV program being played back and viewed (step S205). If the time-shift channel identification processing succeeds in specifying the selected channel (YES in step S206), then the decision part 443 writes the result of time-shift channel identification processing in the processing result storage part 45 through the writing part 446 in correlation to the attribute data of the viewing block data concerned (step S208). If the time-shift channel identification processing fails to specify the selected channel (NO in step S206), then the decision part 443 writes an “unspecified channel” as the result of identification processing in the processing result storage part 45 through the writing part 446 (step S209).

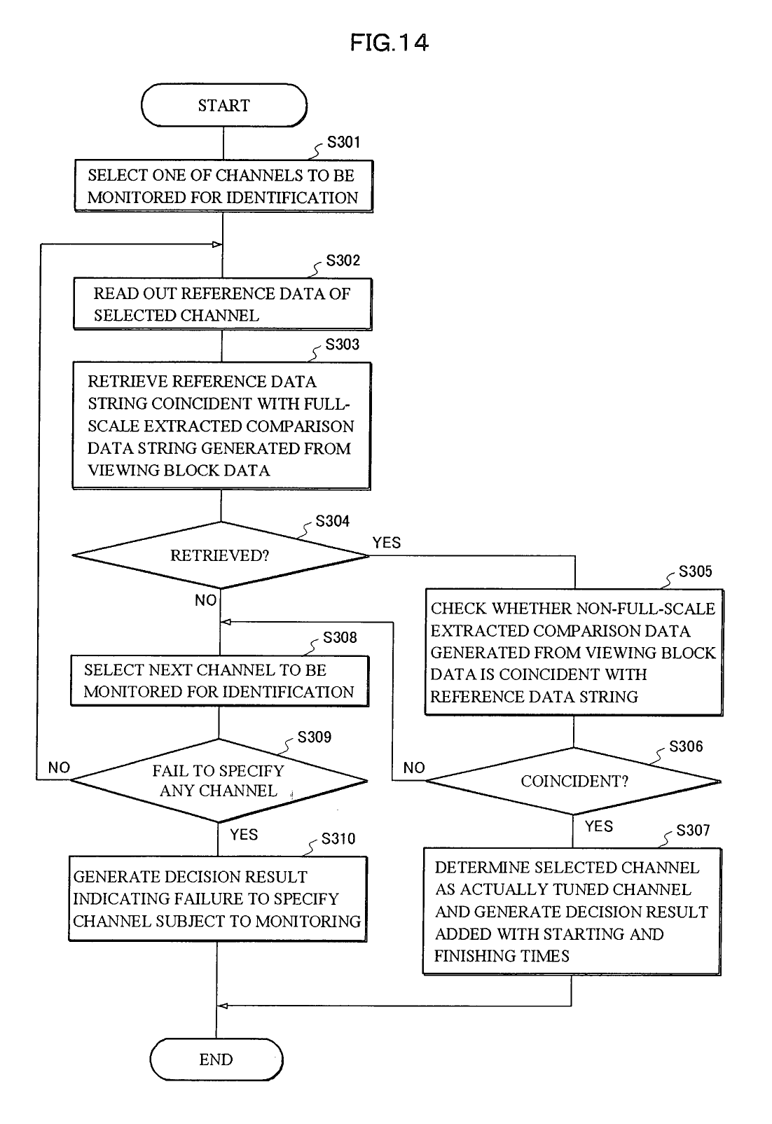

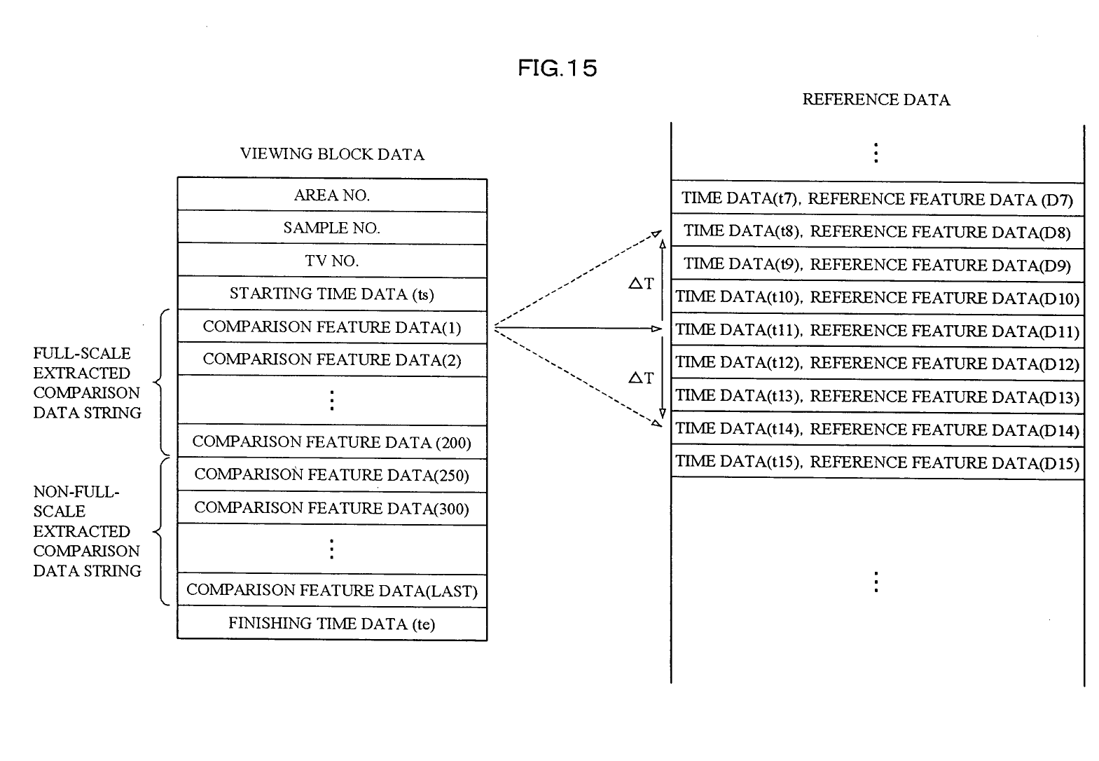

FIG. 14 is a flowchart illustrating in detail the real-time channel identification processing in step S203. The channel decision part 443 selects one of channels to be identified (step S301), then reads out reference data on the selected channel from the reference data storage part 43 through the reference data reading part, and stored the read-out reference data in the storage part 445 (step S302). Then, the identification part 443 retrieves a reference data string that coincides with a full-scale extracted comparison data string (a string of comparison data extracted from each of non-thinned-out data-bursts) in the viewing block data, with consideration given to time-base delays of the both data strings (step S303). More specifically, in the case where a time lag of up to ΔT occurs between the digital audio signal from the digital tuner 11 of the TV 1 and the digital audio signal from the digital tuner 421 of the reference data generating part 42 due to a circuit delays in the circuit operation of tuner sets and in their processing, the timing for decoding broadcast waves, or the like, the decision part 443 makes a comparison, as shown in FIG. 15, between all reference data strings each headed with one of the pieces of reference data within the range from the reference data having time data coincident with (viewing block starting time (ts)−ΔT) to the reference data having time data coincident with (viewing block starting time (ts)+ΔT) and a full-scale extracted comparison data string.

When the decision part 443 has succeeded in retrieving a reference data string coincident with the full-scale extracted comparison data string in the viewing block data (YES in step S304), it makes a check to see if a non-full-scale extracted comparison data string (a string of comparison feature data extracted thinned-out data-bursts) in the viewing block data coincides with the retrieved reference data string (step S305). Specifically speaking, the comparison feature data from the head to the last of the non-full-scale extracted comparison data string are compared one by one with the corresponding pieces of reference data of the retrieved string. For example, in FIG. 15, when it has found out in step S303 that comparison feature data (1) to (200), which constitute the full-scale extracted comparison data string, coincide with a reference feature data string headed by reference feature data having time data t11, a check is made to determine whether the first reference feature data having the time data t11 and 250th, 300th, . . . and subsequent reference feature data coincide with comparison feature data (250), (300), . . . in the viewing block, respectively.

When the non-full-scale extracted comparison data string in the viewing block coincides with the reference data string (YES in step S306), the decision part 433 determines the selected channel as a channel being actually tuned, and generates a decision result added with starting time data and finishing time data in the viewing block data (step S307).

On the other hand, in the event of failure in the retrieval of the reference data string coincident with the full-scale extracted comparison data string in the viewing block data (NO in step S304), and even in the case of succeeding in the retrieval, if the non-full-scale extracted comparison data string in the viewing block does not coincide with the reference data string (NO in step S306), the decision part 443 selects the next channel for monitoring (step S308), then goes back to step S302, repeating the same processing as mentioned above. And in the event that even if the channel decision processing is repeated for all channel selected for monitoring, no channel is specified as a channel being actually tuned (YES In step S309), the decision part 443 provides a decision result to the effect that no channel is specified (step S310).

The time-shift channel decision processing in step S205 in FIG. 13 is performed in substantially the same manner as the real-time channel decision processing depicted in FIG. 14. In step S303 in which to retrieve the reference data string which coincides with the full-scale extracted comparison data string in the viewing block data, however, the reference data is collated with the reference data having time data earlier than (viewing block staring time −ΔT), not with the reference data in the vicinity of the viewing block starting time).

Next, the effects of the above embodiment will be described.

According to this embodiment, the viewing block, which is the viewing period from the start to the end of tuning of the same channel, can be accurately detected by the terminal device 2 in the viewer's home. The reason for this that the terminal device detects a change in the audio data-type by analyzing the preamble of the data-burst generated from the digital audio signal provided from the digital audio output terminal of the TV, and provides, as one viewing block, the viewing period between the time of a change in the audio data-type to the time of the next change. The increased accuracy in the detection of the viewing block leads to the prevention of a failure in the detection of the channel to be monitored, providing enhanced accuracy in channel identification. Furthermore, since no redundant data is sent from the terminal device in the viewer's home to the center apparatus, the load on the part of the center apparatus will be lessened.

According to this embodiment, it is possible to accurately identify even substantially a silent channel, for the reasons given below. That is, even in substantially a silent channel in which reproduced sound of speech does not appear or, if it appears, at a very low level substantially equal to a noise level, the digital audio signal of such a channel contains feature data which clearly distinguishes it from digital audio signals of other channels, and this embodiment compares the feature data on a digital-wise basis.

In addition, according to this embodiment, the comparison feature data is extracted from all data-bursts in the former half portion of the viewing block, but in the latter half portion the data-burst from which to extract the comparison data are thinned out, and consequently, the amount of comparison feature data per data-burst is kept down to 8 bits, 16 bits . . . ; therefore, the viewing block data covers the viewing block completely from its start to end, but the amount of data can be held down in its entirety. For example, assuming that the number of times of channel switching per day is 50, the time of TV operation per day 720 minutes, the size of the attribute data (area number, sample number, TV number, starting time, finishing time, etc.) is 24 bytes, and the size of the comparison feature data to be extracted from one data-burst is 8 bytes, the total size of viewing block data per day is held down to 425, 200 bytes per TV. This amount of data is by far smaller than in the case of extracting analog audio and video signals as the comparison data as described in patent documents 2 and 3. This permits reduction of the communication costs by a decrease in the amount of data for transmission from the terminal device 2 to the center apparatus 4, and reduction of the equipment costs by a decrease in the capacity of the viewing block data storage part 28 of the terminal device 2.

While the present invention has been described above in connection with one embodiment, the invention is not limited specifically thereto but various other additions and modifications may be made. For example, the following configurations are also possible.

While in the above the TV 1 with one digital tuner 11 built therein has been exemplifies as the TV to be monitored for audience measurement, the number of built-in tuners is not limited specifically to one, and TVs having built therein plural kinds of digital tuners such as a terrestrial digital tuner and a BS digital tuner may also be monitored for audience rating. Also it is possible to monitor a TV receiving a digital broadcast by use of STB (Set Top Box).

A personal audience rating survey can be conducted by providing in the terminal device 2 an interface with such equipment as a personal identification signal transmitter for inputting information on the TV viewer and by sending the input personal identification information to the center apparatus 4 together with time information.

What is claimed is:

1. A TV channel selecting status monitoring method which identifies a channel being actually received by a TV which has at least one built-in digital tuner, provides video and audio signals of the channel selected by said built-in digital tuner to a display and a loudspeaker, respectively, and has a digital audio output terminal through which to output a digital audio signal of said selected channel, said method comprising the steps:
a) wherein a terminal device connected to said TV detects a change of audio data-type by analyzing a preamble of a data-burst generated from said digital audio signal output from said digital audio output terminal of said TV, and for each viewing period from the time of the change of audio data-type to the time of the next change of audio data-type, generates viewing block data containing comparison feature data extracted from said data-burst within said viewing period and containing time data on said viewing period;
b) wherein said terminal device sends said generated viewing block data to a center apparatus;
c) wherein said center apparatus receives said viewing block data from said terminal device and stores said received data in a comparison data storage part; and
d) wherein, for each viewing block data stored in said comparison data storage part, said center apparatus identifies said actually selected channel by making a comparison between said comparison feature data contained in said viewing block data and reference feature data extracted from each data-burst generated from a digital audio signal of said channel and contained in reference data together with time data on said data-burst.

2. The method of claim 1, characterized in that said step a) includes a step of extracting said comparison feature data from a predetermined part of said data-burst.

3. The method of claim 2, characterized in that said step a) includes a step of extracting said comparison feature data from only the data-burst within a certain time interval of said viewing period.

4. The method of claim 3, characterized in that said step a) includes a step of extracting said comparison reference data from all of a predetermined number of data-bursts from the start of said viewing period.

5. The method of claim 4, characterized in that said step a) includes a step of extracting said comparison reference data from only some of data-bursts subsequent to said predetermined number of data-bursts.

6. The method of claim 5, characterized in that said step d) includes a step of retrieving reference data of a channel having reference feature data coincident with said predetermined number of comparison reference data contained in said viewing block data, and in the case of said retrieval being successful, making a check to see if comparison feature data except said predetermined number of comparison reference data coincides with reference data of the channel concerned.

7. The method of claim 1, characterized in that said step d) includes a step of performing a real-time channel decision processing of making a comparison between reference feature data of substantially the same time data as that contained in said viewing block data and said comparison feature data in said viewing block data.

8. The method of claim 1, characterized in that said step d) includes a step of performing a time-shift channel decision processing of making a comparison between reference feature data of time data earlier than the time data contained in said viewing block data and said comparison feature data in said viewing block data.

9. A TV channel selecting status monitoring system which identifies a channel being actually received by a TV which has at least one built-in digital tuner, provides video and audio signals of the channel selected by said built-in digital tuner to a display and a loudspeaker, respectively, and has a digital audio output terminal through which to output a digital audio signal of said selected channel, said system comprising:
a terminal device connected to said TV; and
a center apparatus capable of communicating with said terminal device;
wherein said terminal device comprises:
a viewing block data generating part which detects a change of audio data-type by analyzing a preamble of a data-burst generated from said digital audio signal output from said digital audio output terminal of said TV, and for each viewing period from the time of the change of audio data-type to the time of the next change of audio data-type, generates viewing block data containing comparison feature data extracted from said data-burst within said viewing period and containing time data on said viewing period;
a storage part for storing said generated viewing block data; and
a communication part for transmitting said viewing block data stored in said storage part to said center apparatus; and
wherein said center apparatus comprises;
a comparison data storage part for storing said viewing block data transmitted from said terminal device;
a reference data storage part for storing, for each channel monitored for identification, reference data containing reference feature data extracted from a data-burst generated from the digital audio signal of said channel concerned and time data of said data-burst; and
a channel decision processing part for making a decision, for each viewing block data stored in said comparison data storage part, on the channel being monitored for identification by making a comparison between feature data contained in said viewing block data and reference feature data contained in reference data on each channel stored in said reference data storage part.

10. The system of claim 9, characterized in that said viewing block data generating part extracts said comparison feature data from a predetermined part of said data-burst.

11. The system of claim 10, characterized in that said viewing block data generating part extracts said comparison feature data from only the data-burst within a certain time interval of said viewing period.

12. The system of claim 11, characterized in that said viewing block data generating part extracts said comparison feature data from all of a predetermined number of data-bursts from the start of said viewing period.

13. The system of claim 12, characterized in that said viewing block data generating part extracts said comparison reference data from only some of data-bursts subsequent to said predetermined number of data-bursts.

14. The system of claim 13, characterized in that said channel decision processing part retrieves reference data of a channel having reference feature data coincident with said predetermined number of comparison reference data contained in said viewing block data, and in the case of said retrieval being successful, makes a check to see if comparison feature data except said predetermined number of comparison reference data coincides with reference data of said channel concerned.

15. The system of claim 9, characterized in that said channel decision processing part performs a real-time channel decision processing of making a comparison between reference feature data of substantially the same time data as that contained in said viewing block data and said comparison feature data in said viewing block data.

16. The system of claim 9, characterized in that said channel decision processing part performs a time-shift channel decision processing of making a comparison between reference feature data of time data earlier than the time data contained in said viewing block data and said comparison feature data in said viewing block data.

17. A terminal device comprising:
a viewing block data generating part which detects a change of audio data-type by analyzing a preamble of a data-burst generated from a digital audio signal output from a digital audio output terminal of a TV, and for each viewing period from the time of the change of audio data-type to the time of the next change of audio data-type identifying part, generates viewing block data containing comparison feature data extracted from a data-burst within said viewing period and containing time data on said viewing period;
a storage part for storing said generated viewing block data; and
a communication part for transmitting said viewing block data stored in said storage part to a center apparatus.

18. The terminal device of claim 17, characterized in that that said viewing block data generating part extracts said comparison feature data from a predetermined part of said data-burst.

19. The terminal device of claim 18, characterized in that that said viewing block data generating part extracts said comparison feature data from only the data-burst within a certain time interval of said viewing period.

20. The terminal device of claim 19, characterized in that that said viewing block data generating part extracts said comparison feature data from all of a predetermined number of data-bursts from the start of said viewing period.

21. The terminal device of claim 20, characterized in that that said viewing block data generating part extracts said comparison feature data from only some of data-bursts subsequent to said predetermined number of data-bursts.

22. A center apparatus comprising:
a comparison data storage part for receiving from a terminal device and storing viewing block data containing comparison feature data extracted from a data-burst generated from a digital audio signal of a TV within a viewing period from the start to the end of tuning of said TV to the same channel and containing time data of said viewing period;
a reference data storage part for storing, for each channel monitored for identification, reference data containing reference feature data extracted from a data-burst generated from the digital audio signal of said channel concerned and time data of said data-burst; and
a channel decision processing part for making a decision, for each viewing block data stored in said comparison data storage part, on the channel being monitored for identification by making a comparison between feature data contained in said viewing block data and reference feature data contained in reference data on each channel stored in said reference data storage part.

23. The center apparatus of claim 22, characterized in that said channel decision processing part performs a real-time, channel decision processing of making a comparison between reference feature data of substantially the same time data as that contained in said viewing block data and said comparison feature data in said viewing block data.

24. The center apparatus of claim 22, characterized in that said channel decision processing part performs a time-shift channel decision processing of making a comparison between reference feature data of time data earlier than the time data contained in said viewing block data and said comparison feature data in said viewing block data.

25. The center apparatus of claim 22, further comprising:
reference data generating parts 42 each provided in correspondence to one of channels to be identified, for generating reference data which contains reference feature data extracted from each data-burst generated by decoding a digital audio signal from a digital tuner for selecting said corresponding channel and time data of said data burst concerned, and for sending said reference data to said reference data storage part.
